(19) United States
(12) Patent Application Publication
(10) Pub. No.: US 2009/0026033 A1
(43) Pub. Date: Jan. 29, 2009

(54) Magnetorhelogical Clutch with Pot-Type Disks

(75) Inventors: Herbert Steinwender, Raaba (AT); Gerald Schober, Langegg bei Graz (AT)

Correspondence Address: HARNESS, DICKEY & PIERCE, P.L.C., P.O. BOX 828, BLOOMFIELD HILLS, MI, 48303, US

(73) Assignee: MAGNA POWERTRAIN AG & CO KG, Lannach (AT)

(21) Appl. No.: 11/921,256

(22) PCT Filed: May 26, 2006
(86) PCT No.: PCT/EP2006/005026

§ 371 Date: Feb. 28, 2008

(30) Foreign Application Priority Data
May 31, 2005 (AT) GM0358/2005

(51) Int. Cl. F16D 37/02

(52) U.S. Cl. 192/21.5

(57) ABSTRACT

A magnetorheological clutch consists of a stationary part, a primary part and a secondary part, a working space which contains a magnetorheological fluid being formed between primary part and secondary part, in which working space primary discs and secondary discs successively alternate in the radial direction, and a controllable magnetic field acting on the magnetorheological fluid. In order to prevent segregation of the fluid by centrifugal force in a simple type of construction, the working space is L-shaped in longitudinal section, the primary part is a shaft and the secondary part is a pot enclosing the working space, and are of pot-shaped design.

### CROSS-REFERENCE TO RELATED APPLICATIONS

This application is a National Stage of International Application No. PCT/EP2006/005026, filed May 26, 2006. This application claims the benefit of Austrian Patent Application No. GM0358/2005, filed May 31, 2005. The disclosures of the above applications are incorporated herein by reference in their entirety.

### FIELD

The present disclosure relates to a magnetorheological clutch having a stationary part, a rotating primary part having primary disks and a coaxially rotating secondary part having secondary disks, wherein a working space containing magnetorheological fluid is formed between the primary part and the secondary part and in which the primary disks and the secondary disks alternate sequentially in the radial direction and wherein a regulatable magnetic field acts on the magnetorheological fluid. The magnetorheological fluid can be either a liquid or a gas with magnetizable particles suspended therein.

### BACKGROUND

The statements in this section merely provide background information related to the present disclosure and may not constitute prior art.

Power consumption and construction size must be minimized for the use of a magnetorheological clutch in the powertrain of a motor vehicle. There are also demands, such as a wide control range of the transmitted torque, as well as a fast and precise response, to satisfy all dynamic driving demands.

A clutch of this type is known from EP 940 286 A2. The magnetic field is generated by a coil fixed with respect to the housing. The field lines are relatively long due to the manner of construction of the magnetic coil with its yoke, which reduces the size of the active part of the magnetic field that acts on the magnetorheological liquid. An air gap thereby also arises between its yoke and the rotating parts, in particular the disks, and the air gap has to have a substantial width for tolerance reasons. The magnetic field lines are thereby interrupted and the magnetic field acting on the magnetorheological fluid is further weakened. The cylindrical disks give rise to further problems. The suspended particles migrate slowly outwardly, driven by the centrifugal force, cascade-like in serpentine lines between the individual cylindrical disks; the fluid unmixes; and the disks prevent a fast circulation of the fluid which would mix it again. This problem is also addressed in U.S. Pat. No. 6,318,531 which likewise has a magnetorheological clutch of this category as its subject. A further problem is the connection of the cylindrical disks to their axially normal base plates. It is extremely labor intensive and a precise centering and maintenance of the spacings between the individual disks is not possible.

### SUMMARY

The present disclosure improves a generic clutch such that a torque can be transmitted which is as high as possible in a very small working space and with a minimal power consumption, in so doing, the problems of the unmixing and of the connection of the disks to their base parts is solved.

The working space may be L-shaped in longitudinal section, and provides very high density and utilization of the magnetic field lines. The pot-like design of the disks permits a particularly simple shape of the pot which surrounds the working space and which at the same time forms a yoke. Above all, a simple connection to the parts supporting them and a precise centering with an exact maintenance of the intermediate spaces between the disks. In addition, the disks can also be manufactured cheaply and precisely by deep drawing.

The problem of the unmixing is solved by the interaction of the seals with the pot shape of the disks and the secondary part. The seals are at the cylindrical part of the disks, where the centrifugal force acting on the suspended particles is the largest and thus a migration of the particles into the outwardly adjacent gap is suppressed. Thanks to the pot shape, only every second intermediate space needs a seal.

The base parts of the disks guided radially to the axis of rotation of the clutch permit a fluid connection of the individual intermediate spaces between the disks at the point of the smallest radius and minimal centrifugal force. No seals are necessary there and a fluid flow can take place which does not result in unmixing. In addition, the fluid connection facilitates (for instance, by the spline, by means of which the primary disks are connected to their primary part) the filling of the clutch with magnetorheological fluid and the pressure equalization between the intermediate spaces. Overall, a working space is created by the pot shape which is L-shaped in longitudinal section and has L-shaped fluid gaps between the disks.

The inner rims of the base parts of the primary disks are rotationally fixedly connected to the primary part and are separated from one another by spacers, and the secondary disks have outwardly directed rims in the manner of a hat brim at their side remote from the base parts, the rims connected to the secondary part in a manner contacting one another in the axial direction. The spacers provide the same axial spacings of the primary disks. The secondary disks are thus clamped between the pot rim and the cover and are equally centered without special measures. Since the connection for all disks is of the same radius, a simple spline is, for example, sufficient.

To improve the fluid connection between the individual fluid gaps, it is of advantage to provide the base parts of the primary disks, and optionally also of the secondary disks, with passage openings in the vicinity of the inner rims, if the clearances at the spline are not sufficient for this. This facilitates the filling and the pressure equalization. No unmixing can take place through the passage openings because the particles would have to migrate against the centrifugal force for this purpose in order to reach them. It is advantageous for the reduction of the magnetic stray flux if the inner rims of the base parts of the primary disks are seated on an intermediate ring which consists of a material of small magnetic permeability and which is in turn rotationally fixedly connected to the primary part. The material portion of the magnetically conductive disks is thus reduced.

There are different possibilities for the design of the seals within the framework of the invention. In an advantageous embodiment, the regions of the cylindrical parts of the disks remote from the base parts have restricted portions which extend all around as seals and which at least almost contact the adjacent disk. The restricted portions can be attached either to the primary disks or to the secondary disks. The restricted portions are more favorable from a technical production aspect at the primary disks. A secondary disk is adjacent to the primary disk and vice versa. The sealing gap thus comes to lie such that the particles would have to migrate inwardly due to the restricted portion in order to reach the sealing gap at all. In addition, the contact of the disks at the sealing gaps has a positive effect on the shape and on the distribution of the magnetic field lines.

Rings made of a slide-friendly material of small magnetic permeability are provided as seals at the rims of the primary disks remote from the base parts.

There are various base shapes with variants for their design within the framework of the invention with respect to the arrangement of the parts generating and guiding the magnetic field (magnetic coils and yokes). They all produce a particularly dense, closed and uniform shape of the magnetic field lines.

In a first basic shape, the primary part has a magnetic field generator with at least one first yoke and is surrounded by it, said magnetic field generator forming the inner boundary of the working space, with a second yoke being formed in the outer boundary of the working space and the pot of the secondary part being closed by a cover on its side remote from the base. There is thereby a minimal centrifugal force effect on the coil and yoke. The cover can furthermore be used for the fixing of the flange parts.

In a second basic shape, the secondary part additionally has an insert part inwardly bounding the working space and contains the magnetic field generator. In a third basic shape, the first yoke of the magnetic field generator is fixedly connected to the housing and the insert part and the cylindrical part of the pot form a second yoke.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a longitudinal section through a first basic shape;

FIG. 2 is a variant of FIG. 1;

FIG. 3 illustrates a first embodiment of FIG. 1;

FIG. 4 illustrates a second embodiment of FIG. 1;

FIG. 5 illustrates a third embodiment of FIG. 1;

FIG. 6 illustrates a cross-section of FIG. 5;

FIG. 7 illustrates detail A in FIG. 1 in three different variants (a, b, c);

FIG. 8 illustrates a longitudinal section through a second basic shape; and

FIG. 9 illustrates a longitudinal section through a third basic shape.

### DETAILED DESCRIPTION

The following description is merely exemplary in nature and is not intended to limit the present disclosure, application, or uses.

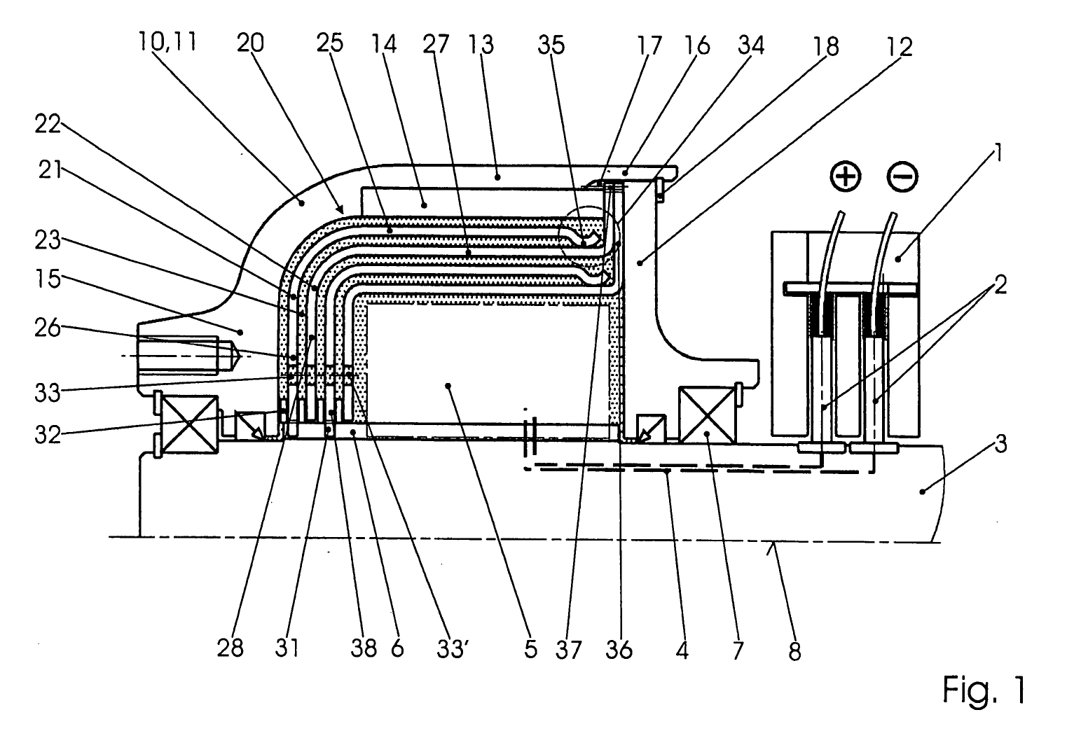

In FIG. 1, a stationary part 1 with sliding contacts 2 for the power supply to a primary part 3 is shown of a housing (not shown) of a magnetorheological clutch. Primary part 3 is a shaft which is supported in the housing. Primary part 3 may drive or be driven, which depends on the respective load state (traction mode or braking mode) in use in a motor vehicle. In primary part 3, a power supply line 4 leads from sliding contacts 2 to a magnetic field generator 5 which is described in detail below. Primary part 3 has a first spline 6. The axis of rotation of primary part 3 and of the entire clutch is marked by 8.

A secondary part 10 is supported in bearings 7 with respect to the primary part 3. Secondary part 10 consists of a substantially rotationally symmetrical pot 11 with a cover 12, which may be substantially an axially normal plate. Pot 11 and cover 12 form end plates in which bearings 7 are seated. Pot 11 here consists in one piece of a cylindrical part 13 and a base part 15 on the side opposite cover 12. Cylindrical part 13 has a second yoke in its interior, which extends all around and which forms a shoulder 16 and a second spline 17. Cover 12, held by a circlip 18, for example, is seated on the latter.

Pot 11 and cover 12 bound a working space 20 outwardly and the magnetic field generator 5 bounds it inwardly. Working space 20 is “L”-shaped in longitudinal section and accepts a disk packet which consists of a number of primary disks 21 and secondary disks 22 between which respective fluid gaps 23 remain free. They are part of the working space 20 which is filled with a magnetorheological fluid. Primary disks 21 consist of a cylindrical part 25 and a substantially axially normal base part 26, which merge into one another with a rounded portion. The rounded portion facilitates the manufacture of the primary disks 21 by deep drawing. The secondary disks 22 equally consist of a cylindrical part 27 and a base part 28 disposed in an axially normal plane. The primary shafts 21 have a section 31 in their base part 26 at an interior rim 38 surrounding primary part 3, and are seated rotationally fixedly on first spline 6 with the section, separated from adjacent disks by spacers 32.

There may be a radial spacing, not shown, between section 31 and spine 6 that permits the passage of fluid. Primary disks 21 may be installed very simply and very precisely using a thickness of spacers 32 and the centration by spline 6. If play in the first spline 6 is not sufficient, passage openings 33 for the connection of the individual fluid gaps are provided at a lowest possible spacing from the axis of rotation 8. A seal 34, here forming the rim of the cylindrical part 25 of the primary disks 21, may be provided at the side opposite from the base parts 26 and 28 of disks 21 and 22. Seal 34 here consists of a restricted portion 35 of primary disks 21, which forms their rim and which extends all round.

Inner rim 38 of base parts 28 of secondary disks 22 extend up to first spline 6, but without contacting it. Fluid may thus also pass through there. Additional passage openings 33′ may also be provided on the same radius as passage openings 33 of secondary disks 21. At a side remote from the base parts 28, disks 22 have a flange part 36 as an outer rim, which lies in an axially normal plane and forms the “brim” of a hat. At its outer rim, flange part 36 has teeth 37 all around which engage into second spline 17 in secondary part 10 and establish a rotationally fixed and centered connection. Flange parts 36 of secondary disks 22 contact one another in the axial direction and are clamped together between the second yoke 14 and cover 12. Their position with respect to the primary disks 21 can thereby be precisely fixed, and by their centration in the second spline 17.

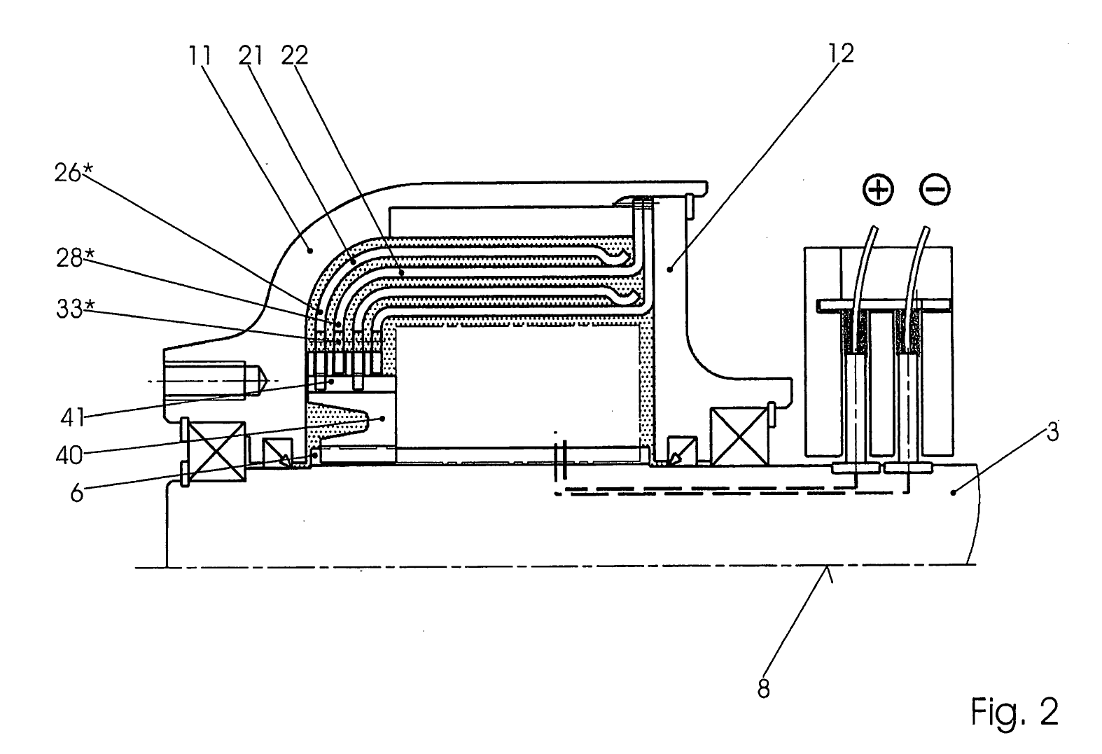

FIG. 2 differs from FIG. 1 in that the base parts 26*, 28* of the disks do not reach up to the shaft forming primary part 3, but up to an intermediate ring 40, which has a third spline 41 for the acceptance of primary disks 21 at its outer periphery and whose inner rim is in turn seated on first spline 6 of primary part 3. Working space 20 thereby does not reach fully up to primary part 3, but third spline 41 has to lie on a smaller radius than the cylindrical part of the innermost disk with respect to the axis of rotation 8. The intermediate portion consists of a material of small magnetic permeability and has the purpose of reducing the material portion of the magnetically conductive disks. In this manner, the magnetic stray flux in the disks may be reduced.

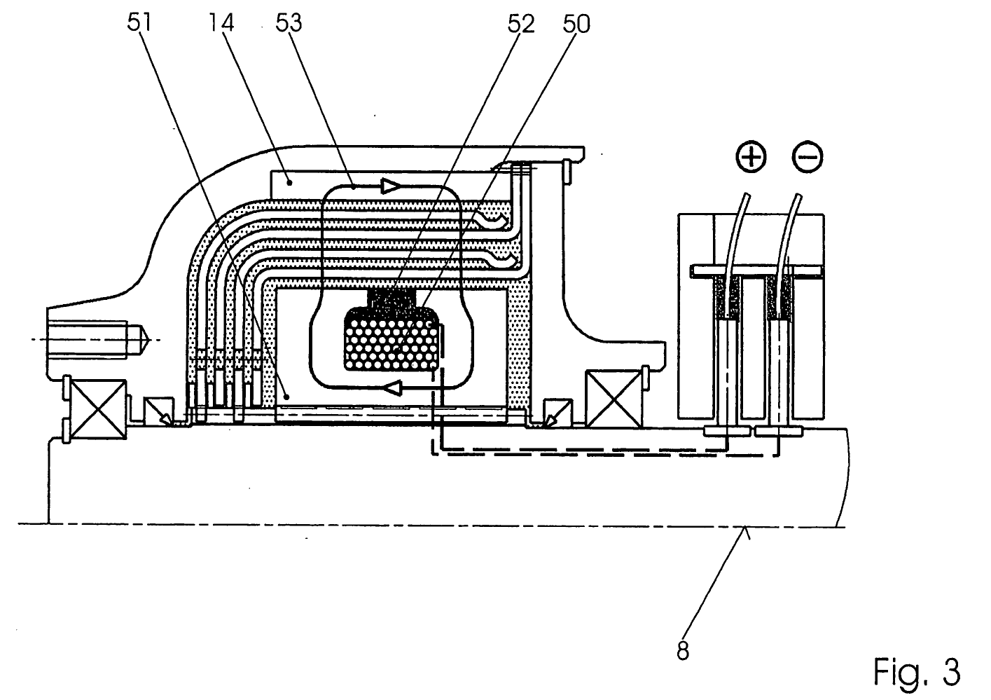

In FIG. 1, magnetic field generator 5 is indicated by a rectangle in broken lines. In FIG. 3, magnetic field generator 5 consists of a magnetic coil 51 whose winding axis is the axis of rotation 8 and of a first yoke 51 which surrounds it and which only has a zone 52 of less magnetic permeability all around radially outside the coil 50 to prevent short-circuited field lines. The magnetic field created in this manner is characterized by a field line 53.

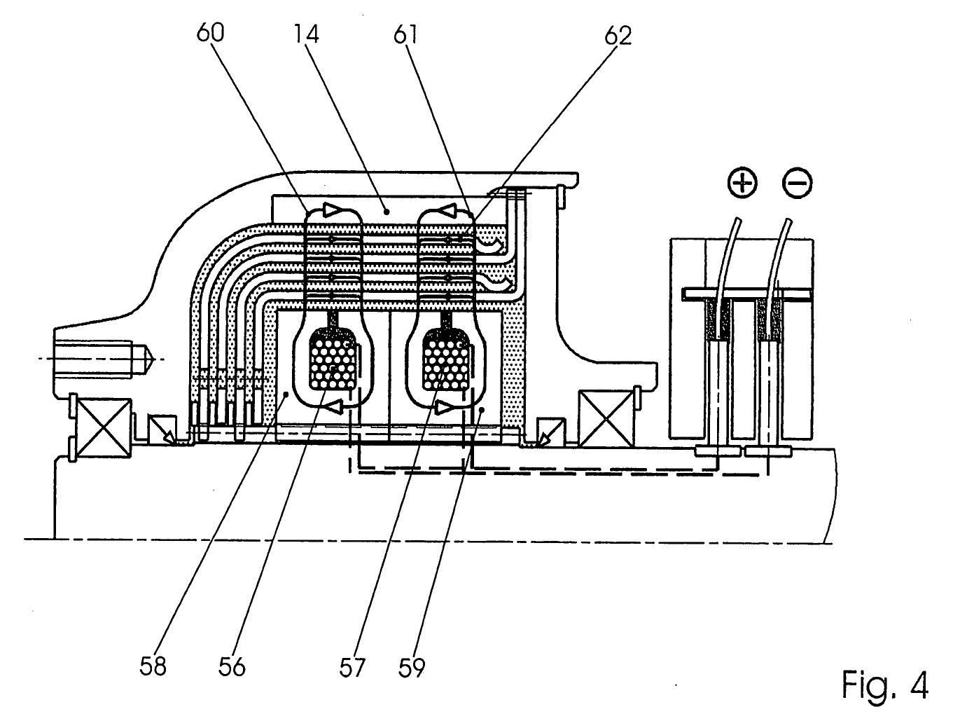

In FIG. 4, the constellation of FIG. 3 is doubled. Two oppositely poled magnetic coils 56 and 57 are arranged next to one another and each is surrounded by a first yoke 58 and 59, which is substantially the same as the first yoke 51 in FIG. 3. The adjacent magnetic fields thus generated are again indicated by a respective field line 60 and 61. As a special feature, the disks are not made of a material of high magnetic permeability, but of a material of moderate magnetic permeability so that weak short-circuit field lines 62 are formed. A uniform distribution of the magnetic field lines may thus also be achieved. The number of coils may also be increased, whereby a plurality of small individual magnetic currents are produced at magnetic field lines, which minimizes the formation of eddy currents.

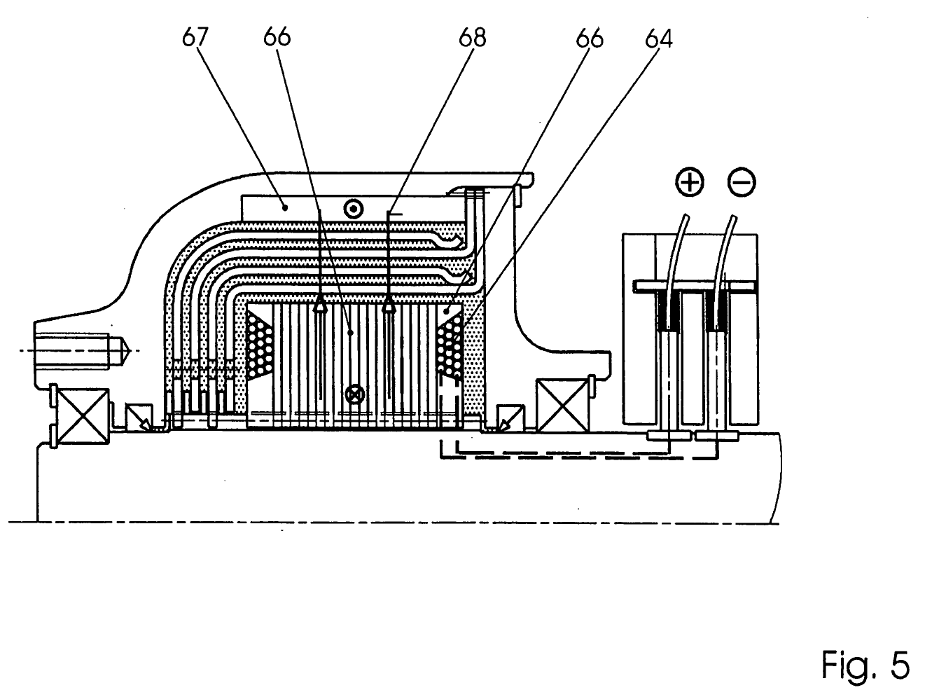

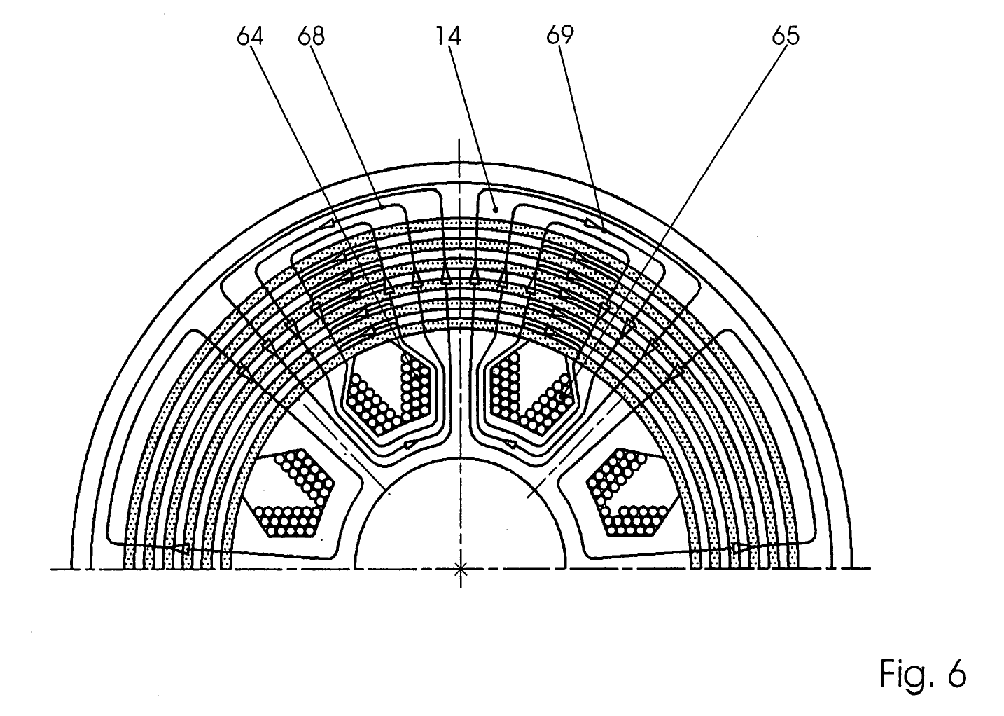

In FIGS. 5 and 6, a number of alternately oppositely poled magnetic coils 64 and 65 are arranged following one another in the peripheral direction (see FIG. 6). The corresponding yokes 66 and 67 are likewise distributed over the periphery of primary part 3. The field lines 68 and 69 extend as shown in FIG. 6.

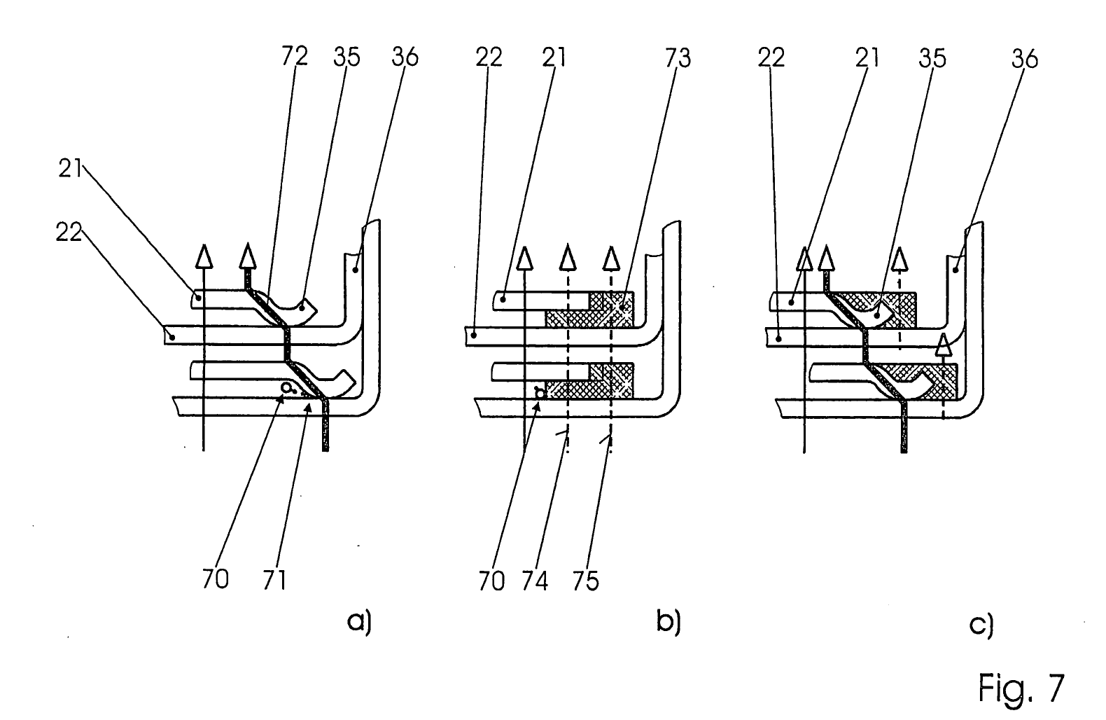

In FIG. 7, the seals 34 are shown in three variants. The variant a) corresponds to FIG. 1. Primary disks 21 end in an inwardly flanged rim 35, which forms a restricted portion all around and which contacts the secondary disk 22 lying thereunder—or which almost contacts it in view of hydrodynamic lubrication effects. A particle suspended in the magnetorheological fluid is marked by 70. It is indicated that it would have to migrate somewhat inwardly against the centrifugal force to move to the sealing gap 71 because seal 34 is actually formed by a restricted portion 71 of the primary disk, and not by a bulge of a secondary disk. In this manner, the passage of particles through sealing gap 71, and thus a cascading unmixing of the magnetorheological fluid, is reliably prevented. Furthermore, a field line 72 is drawn to show that a collective effect is exerted onto the field lines by the contacting of primary disks 21 and secondary disks 22. In variant b), a ring 73 extends all round a slide-friendly material, for example a suitable plastic, that is fastened to the rim of the primary disks 21 instead of the restricted portion. It is indicated by the in broken lines arrows 74 that these rings 73 form a field gradient with an applied magnetic field which drives the suspended particles toward the stronger magnetic field and thus away from the sealing gap 75. In variant c), the variants a) and b) are combined, whereby the effects of the two variants are added.

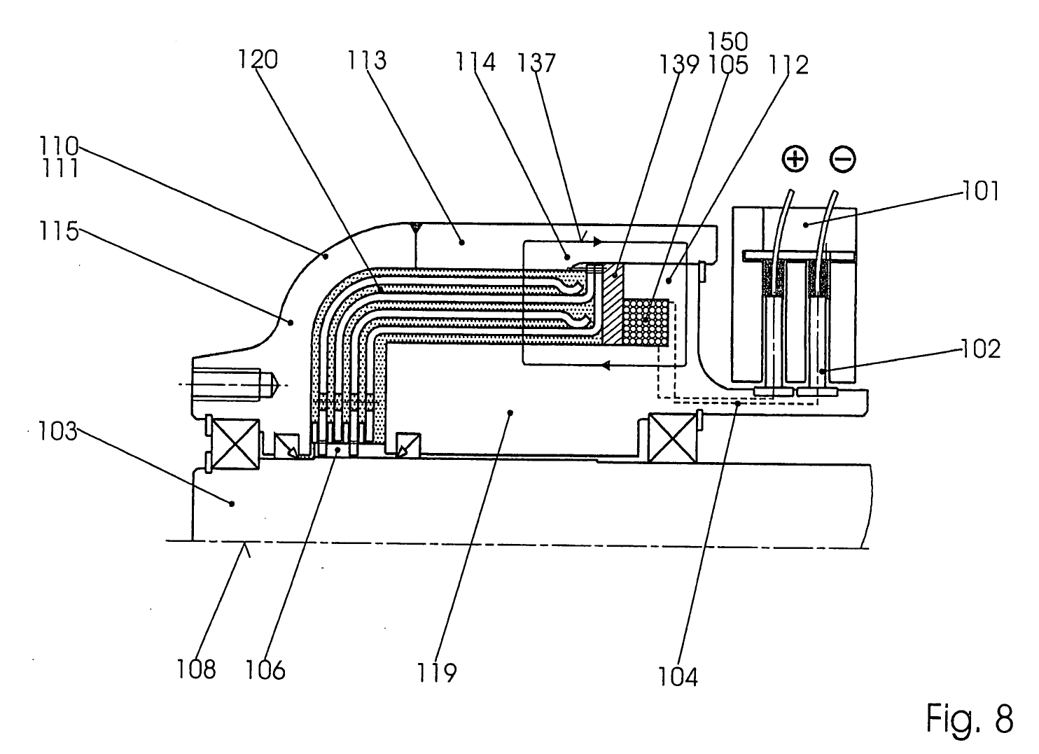

FIG. 8 differs from FIG. 1 (with a reference numeral increased by 100) in that the magnetic field generator 105 rotates with the secondary part 110. Accordingly, the sliding contacts 102 fastened to the housing 101 are conductively connected via conductors 104 to the magnetic field generator 105, here a coil with the winding axis 108. The secondary part 110 has, at the side remote from its base 115, a cover 112, which is connected to or is in one piece with an insert 119. The cover 112 accepts the magnetic field generator 105 and, together with the insert 119 and the cylindrical part 113 of the secondary part 110, forms a yoke, which is only interrupted by the working space 120. For the guidance of the magnetic field lines 137, a ring 139 consisting of a material of small magnetic permeability is inserted between the magnetic field generator 105 and the working space 120.

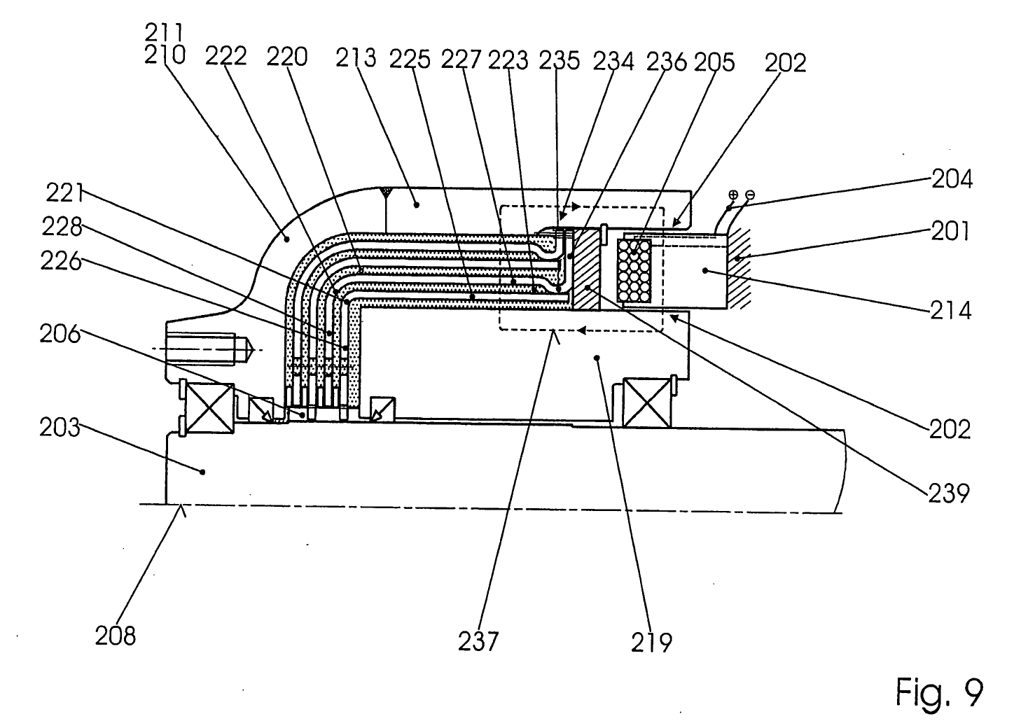

FIG. 9 differs from FIG. 1 (with reference numerals increased by 200) in that the magnetic field generator 205 is attached with its first yoke 214 to the housing 201, that is it is stationary, and by a modification of the seal 234. The secondary part 210 again has the insert 219 which is part of the secondary part and is connected thereto in a manner which is not shown. The insert 219 and the cylindrical part 213 of the secondary part 210 form a second yoke. The field lines 237 have air gaps 202 to be overcome. For the guidance of the magnetic field lines 237, a ring 239 consisting of a material of small magnetic permeability may be inserted between the magnetic field generator 205 and the working space 220.

The modification of the seal 234 differs from that of FIG. 1 in that the restricted portions 235 may be attached to the secondary disks 222. Their cylindrical part 227 forms the restricted portions and then merges directly into the flange part 236 which has, for example, the shape of the brim of a hat. Fluid gaps 223 can thus also be formed which are sealed with a smallest radius.

1-17. (canceled)

18. A magnetorheological clutch comprising:
a rotatable primary part;
a rotatable secondary part;
a working space containing magnetorheological fluid formed between the primary part and the secondary part; and
primary disks fixed for rotation with the primary part being interleaved with secondary disks fixed for rotation with the secondary part, the secondary part being cup-shaped and surrounding the working space, the primary disks and the secondary disks being cup-shaped and positioned within the working space in communication with the magnetorheological fluid to transfer torque between the primary and secondary parts in response to exposure to a magnetic field.

19. The magnetorheological clutch of claim 18, wherein the primary disks include cylindrically shaped portions and base portions, the base portions being rotationally fixedly connected to the primary part and separated from one another by spacers.

20. The magnetorheological clutch of claim 19, wherein the secondary disks have radially outwardly extending flanges connected to the secondary part in contact with one another.

21. The magnetorheological clutch of claim 18, further including seals positioned between cylindrically shaped portions of adjacent primary and secondary disks.

22. The magnetorheological clutch of claim 21, wherein one of the seals is formed by a portion of one of the primary and secondary disks being shaped as a ring in contact with the other one of the primary and secondary disks.

23. The magnetorheological clutch of claim 22, wherein the ring is integrally formed with the one disk.

24. The magnetorheological clutch of claim 18, further including a magnetic field generator positioned between a radially inner one of the first and second disks and the primary part defining an inner boundary of the working space.

25. The magnetorheological clutch of claim 18, wherein inner rims of the primary disks are seated on an intermediate ring which is made of a material of low magnetic permeability and is in turn rotationally fixedly connected to the primary part.

26. The magnetorheological clutch of claim 18, wherein rings of a slide-friendly material of low magnetic permeability are provided as seals between cylindrically shaped portions of the primary and secondary disks.

27. The magnetorheological clutch of claim 24, wherein the magnetic field generator is fixed for rotation with the primary part.

28. The magnetorheological clutch of claim 24, wherein the magnetic field generator includes a coil with a winding axis concentric with the axis of rotation of the primary part and a first yoke surrounding the coil.

29. The magnetorheological clutch of claim 28, wherein the first yoke includes a C-shape in a longitudinal section.

30. The magnetorheological clutch of claim 29, further including a second yoke formed in the outer boundary of the working space, the secondary part being closed by a cover.

31. The magnetorheological clutch of claim 24, wherein the magnetic field generator consists of two coils which are sequential in the axial direction, each coil having a winding axis concentric with an axis of rotation of the primary part and of two yokes positioned sequentially in the axial direction, each yoke surrounding one of the coils and having a C-shape in a longitudinal section.

32. The magnetorheological clutch of claim 24, wherein the magnetic field generator consists of coils sequential in alternating polarity in the peripheral direction.

33. The magnetorheological of claim 18, wherein the secondary part contains the magnetic field generator.

34. The magnetorheological clutch of claim 33, wherein the magnetic field generator is a coil with a winding axis concentric with an axis of rotation of the secondary part and a first yoke surrounding the coil in a C-shape in a longitudinal section.

35. The magnetorheological clutch of claim 33, wherein the magnetic field generator consists of coils sequential in alternating polarity in the peripheral direction.

36. The magnetorheological clutch of claim 18, wherein the working space is L-shaped in a longitudinal section.

37. A magnetorheological clutch comprising:
a rotatable primary part;
a rotatable cup-shaped secondary part surrounding the primary part;
a working space containing magnetorheological fluid formed between the primary part and the secondary part;
a magnetic field generator;
primary disks fixed for rotation with the primary part, the primary disks and the secondary disks being cup-shaped and nested with each other in an alternating patters within the working space in communication with the magnetorheological fluid to transfer torque between the primary and secondary parts in response to exposure to a magnetic field provided by the magnetic field generator.

38. The magnetorheological clutch of claim 37, wherein each primary and secondary disk includes a substantially cylindrically shaped portion and a base portion having an aperture defined by an inner rim.

39. The magnetorheological clutch of claim 38, wherein the inner rim of each primary disk is fixed for rotation with the primary part and the inner rim of each secondary disk is proximate to and spaced apart from the primary part.

40. The magnetorheological clutch of claim 39, wherein each of the secondary disks includes a radially extending flange fixed for rotation with the secondary part.

41. The magnetorheological clutch of claim 40, wherein the flanges are clamped to one another.

42. The magnetorheological clutch of claim 37, further including seals positioned between cylindrically shaped portions of adjacent primary and secondary disks.

43. The magnetorheological clutch of claim 42, wherein one of the seals is formed by a portion of one of the primary and secondary disks being shaped as a ring in contact with the other one of the primary and secondary disks.

44. The magnetorheological clutch of claim 37, wherein each of the primary and secondary disks includes an aperture extending therethough to allow passage of magnetorheological fluid.

45. The magnetorheological clutch of claim 37, wherein the magnetic field generator includes a coil with a winding axis concentric with the axis of rotation of the primary part and a first yoke surrounding the coil.
